(19) United States
(12) Patent Application Publication
(10) Pub. No.: US 2023/0178057 A1
(43) Pub. Date: Jun. 8, 2023

(54) GENERATING MUSIC OUT OF A DATABASE OF SETS OF NOTES

(71) Applicant: INDEPENDENT DIGITAL Sp. z.o.o. [PL]/[PL], Warszawa (PL)

(72) Inventors: Marek PLUTA, Kraków (PL); Joanna KWIECIEÑ, Wasniów (PL); Colin LEWIS, Warszawa (PL); Andrzej DABROWSKI, Warszawa (PL); Marek WLODARCZYK, Zyrardów (PL)

(21) Appl. No.: 18/012,116

(22) PCT Filed: Jun. 24, 2021
(86) PCT No.: PCT/PL2021/000039

§ 371 Date: Dec. 21, 2022

(30) Foreign Application Priority Data
Jun. 30, 2020 (PL) 434520

(51) Int. Cl. G10H 1/00

(52) U.S. Cl. CPC G10H 1/0025; G10H 1/0066; G10H 2210/031; G10H 2210/105; G10H 2210/111; G10H 2210/145; G10H 2240/056; G10H 2240/125; G10H 2240/131; G10H 2240/145; G10H 2250/005

(57) ABSTRACT

A method of generating music contents from input music contents that includes development of models of music composition generation on the basis of business rules and composition rules. In parallel, sounds are prepared, which may be saved in the sound repository. Then, models in the form of source code are sent to a melody generator. Firstly, the generator is set with specific parameters using a controller conforming to MIDI standards and supplemented with composition characteristics read from the user preference database. Next, the contents are sent to automatic generation based on artificial intelligence algorithms and the digital score of the composition with the desired characteristics is generated. Sound tracks of individual instruments are rendered and the rendered tracks are mixed into the final music record. Next, the composition and its record are verified by the critic module using algorithms based on neural networks.

The subject of the invention is a method of generating music contents, based on algorithms of sequential processes performed on input data sets.

Algorithms should be understood in this disclosure as a sequence of actions performed on data in the form of a music contents set, formed according to compositional rules created on the basis of user preferences, business and legal rules standardising organisation of the process of generating music contents and their recordings.

Business rules should be understood as a statement, which defines the business aspect aimed at controlling or influencing business behaviour by informing that there are specific requirements related to behaviour, actions and practices or procedures executed within the given user activity. For the purpose of this disclosure of the solution, business rules have been merged with music composing rules.

Business rules with music composing rules should be understood as any set of rules of music compositions, taking into account sales estimation of musical forms and standards of music composition.

The term of atomic sound repository should be understood as a set of single note recordings.

During the process of generating music contents, algorithms perform a series of processes, aimed at creation of a generator in the first step, with said generator generating a digital musical score of a model provided with parameters and composition characteristics in the generator, according to user preferences. Music contents are generated in this area of generator operation, on the level of a technical composition.

Music contents on technical level should be understood as a developed model resulting from a range of executed processes, aimed at generator creation. The generator creation process is divided into two stages, wherein in the first sub-stage of the first stage, contents are created on an abstraction level as an element of the form, in the second sub-stage, the abstract contents are converted into a digital musical score of each part of the given instrument separately, containing the form, layers of harmony and melody, shaped by setting composition parameters and characteristics in the generator, according to user preferences.

In the second stage of the music contents generation process, the digital score is processed such that it is transformed into a recording in the specified sound form, using sampling synthesis and samples as recordings of single sounds. Sampling synthesis should be understood as the process of music contents creation using a part of a previously prepared music recording, known as a sound sample, as an element of a newly created composition.

During the rendering stage, music contents in the form of a model are replaced by a sequencer and a sampler, using sound samples, into the form of a recording of individual instruments, separately. Such created contents are subjected to applying sound effects through digital signal processing (DSP), and mixing of separate parts into a multi-instrument recording in the next stage. The final recording is obtained and verified by a critic module based on artificial intelligence algorithms of neural networks. During this stage, a composition of artistic nature is obtained, with compositional advantages conforming to business standards and compositional rules. Next, the composition is exported to the distribution module of the platform.

A range of solutions generating music compositions is known. A known solution is presented in the patent publication KR 20190100543. It discloses an electronic device, including: a display, a processor connected electrically to the display, a memory connected to the processor, wherein when the processing takes place, the processor checks the specified input parameters and output sound tracks and identifies sound parameters on the basis of an artificial intelligence algorithm. The electronic device stores instructions for verification of appropriate information about the composition and displaying auxiliary information related to input correction of the sound track on the display according to the confirmed information about the composition. The defined parameters include precise information, in particular about the musical style, about the musical instrument, rhythm, tempo and the music genre.

Another known solution is disclosed in the patent document CN 110211556. It discloses a method and a device for music file processing, a terminal and a memory medium. The processing method includes the following stages: first data of human voice is collected, intended to introduce target sounds, obtaining reverb parameters accepted by data of the target human voice, corresponding to target music. First data of human voice is processed according to reverb parameters, and second data of human voice is obtained. Data of human voice and of the accompanying music corresponding to the target music are then processed, synthesised and the target music file is obtained.

Another known solution is presented in the patent disclosure KR 20190105254. It discloses a solution intended to provide a fully digital sound processing device, which directly receives digital signal of a sound source. The processing takes place on the basis of a file containing a digital sound source, audio signal processing takes place fully digitally, in connection with the input signal of the digital sound source. The audio signal is then sent to a loudspeaker. After direct introduction of the digital signal from a digital sound source file, the entire signal processing may be subsequently performed digitally, and the audio signal may be processed adaptatively, on the basis of artificial intelligence.

According to the invention, the method of generating music contents is based on a series of sequential processes, the operation and course of which are based on artificial intelligence algorithms. The process of music contents generation takes place using a controller corresponding to the MIDI standards. Business rules enabling automatic creation of music tracks according to user preferences were created. Automatic generation of music contents is possible by solutions operating within the platform, such as a user preference database, repository resources, business rules, models used in generation of music compositions of the given type and a melody generator, where parameters and characteristics for models of instrument form and lines are specified. Models are created on the technical level and further processed according to music input file modification algorithms, such that the final recording is generated, and after its verification the composition containing the intended compositional and artistic load is obtained.

The method of generating music contents according to the invention is characterised in that the input sound samples are processed according to input music file modification algorithms, related, in particular, to characteristics such as tempo, mood of the song, the music genre, duration and the scope of contents modulation. This results in a composition with the intended artistic expression. The first stage of the generation process includes construction of music contents on the technical level, in the form of models. Technical contents are obtained as a result of a range of processes focused on generator creation. Execution of the series of processes includes analysis of the input music contents in terms of the existence of patterns once the input contents are provided. Next, the patterns are saved in the database of business rules and music composition rules used to develop the music composition generation models of the given type. Thus, a melody generator is created, used to generate a digital score of the parts of the given instrument. A database of atomic sounds is prepared in general and then sent to the generator, where parameters are set using a controlling device conforming to MIDI standards. Thus created models are subjected to automatic generation of a digital score and parts for individual instruments are created and subsequently rendered to music tracks for each instrument. A record on an artistic level is obtained. Next, the record is polished and mixed. The final version of the record is recorded and next the composition and its record is verified by the critic module. After verification, the record is exported to a distribution module of a dedicated platform.

In the preferred embodiment of the invention, the final music record is created using artificial intelligence algorithms during the stage of analysis in terms of the presence of existing patterns, preparation of composition generation models, creation of a melody generator and sound preparation.

In another preferred embodiment of the invention, sound samples are created simultaneously with contents saving in the repository.

In another preferred embodiment of the solution, the developed models are sent to be read and a digital note record of the composition with the desired characteristics is generated automatically.

In another preferred embodiment of the invention, sound tracks of the instruments are rendered using repository resources.

In another preferred embodiment of the invention, the composition and its record are verified using artificial intelligence and the process of generating music contents is repeated from the beginning if the record does not pass verification.

Using ready patterns of diagrams and samples, a user without special instrumental and hardware resources and with substantial knowledge on the level of a programmer or of a sound engineer, using a controller in order to specify the characteristics of sound contents shall be able to create fully fledged music contents with artistic value, prepared according to individually specified composition preferences.

Artificial intelligence algorithms are used during the process of music contents creation, resulting in an effect of work of an entire team of specialists responsible for generation of such music contents using traditional tools. The operation of the generator is supported and controlled by a controller based on the MIDI standard. The fully digital generation of musical contents using a controller gives the user the opportunity to specify instructions for the generator, by specifying base parameters, in particular for the genre, tempo, mood, duration and content modulation parameters imparting individual contents. The work of the user is additionally supported by the functional repository of sounds containing sounds in the form of single notes. Music tracks for individual instruments are rendered to a form next subjected to mixing and specified to the level according to the intended, artistic composition. The algorithm, based on operation of multilayer feedforward neural networks, verifies the composition and its record in terms of conformity with composition assumptions, in particular for conformity with preferences and business standards effective during composition. The music contents may be generated without limitations. The generator creation process takes place one time. The generated music contents may be distributed.

The subject of the invention is presented in an example embodiment in the attached drawing, which illustrates an example block diagram of music contents generation.

The block diagram presents the course of individual operations executing the subject of the invention, and indicates the sets and databases used during generation of new music contents using the method according to the invention. The terms music contents, composition, composition and its record are used in this disclosure in order to designate the result of the method according to the invention. A controller conforming to the MIDI standard is an element required to execute the method according to the invention.

In the block diagram presented in the figure, each “+” symbol should understood as a conjunction of a series of processes following in a sequence during a single period of time.

The arrows denoted with a dotted line along their length, should be understood as an indication of the sequence of actions occurring in the past compared to the sequence of activities indicated with arrows denoted with a continuous line along their length.

Each first arrow leading to the tile of the database 25 should be understood as a “saved in” arrow, while each arrow leading from the tile of the database 25 should be understood as “read in”.

Existing compositions should be understood as existing sound compositions or sound samples.

The term “composition and its record” during the stage of exporting to the distribution module of the platform 23 should be understood such that not only the record itself is verified, but also i.e. some of the information regarding parameters set by the user and characteristics of the composition 12, including the composition concept, e.g. its genre.

The term of contents on the technical level 26 should be understood as the MIDI file and additional data sent to the generator in the form of a technical algorithm and of the source code.

Sequencer 28a should be understood as an electronic device or a computer program storing not the sequence of sounds, but a sequence of instructions controlling the synthesiser, including parameters and enabling its multiple playback.

Sampler 28b is understood as an electronic music instrument or a computer program enabling digital recording of any sound, and its subsequent use as any traditional music sound.

The area of operation of the sampler and of the sequencer should be understood as tandem operation of modules: 28a and 28b on MIDI files and data related to music contents, comprising instructions for the rendering process 16.

Verification by the AI critic module 19 should be understood as verification of the record and of its composition by a module based on operation of artificial intelligence algorithms based on artificial neural networks. These are learning algorithms comprising of networks of artificial neurons, first and foremost able to generalise the observed data. The network learning term should be understood as forcing the network to react to the selected input parameter in a specific manner.

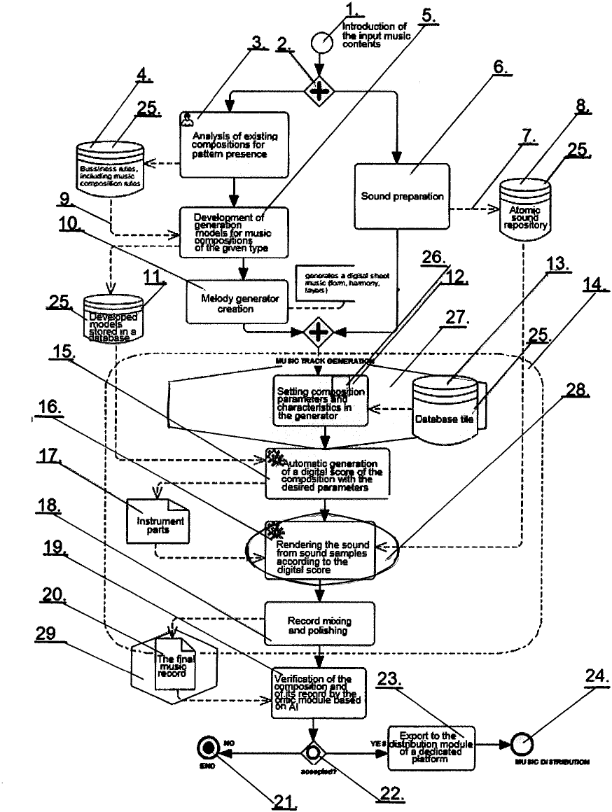

As shown in FIG. 1, the process of generating music contents begins with generator formation, wherein input music contents 1 from existing compositions are analysed first. The two track nature of the process lies in the fact that existing compositions are analysed in terms of the existence of patterns 3 of existing compositions simultaneously with music composition generation models 5 are developed, the melody generator 10 is created and sounds 6 are prepared. Thus generated models on the technical level 27 in the form of source code are introduced into the generator 14, for which parameters and characteristics are set. Setting characteristics and parameters for the generator is preferably performed using a controller 26 conforming to the MIDI standards.

Contents from the generator as models on the technical level 27 are sent to the generation process, where a digital score of the composition with the required characteristics 15 is generated automatically on the basis of artificial intelligence algorithms and parts for individual instruments 17 are next obtained. The created parts 17 are sent as information analysed in the field of sequencer and sampler 28 operation and rendered 16 for each instrument separately, such that using the sequencer and the sampler, with samples, digital score of each part of the given instrument are changed to a sound form and the record form is created separately for individual instruments. Next, the record is polished and mixed 18. Thus, the final music record 20 is obtained and sent to verification. The composition 27 and its record 20 are verified using the critic module 19 base on specialist neural network algorithms. The final music contents are exported 23 and sent to distribution 24. If the composition and its record are verified negatively in the critic module 19, the process is stopped at this stage an the automatic generator 16 generates new contents according to the set parameters and characteristics, preferably using user preference databases 13.

In this embodiment of the invention, the prepared music contents are saved in the sound repository 8 during the sound preparation stage 6.

In this embodiment of the invention, the generator has composition characteristics and parameters set using user preference databases 13.

In another embodiment of the invention, generation models for music composition of the given type are developed and saved in a database 11 of prepared models, from which these models are read during the stage of automatic generation of the digital score of the composition with the desired parameters 15.

List of figure references

| | |
|---|---|
| 1. | Introduction of the input music contents |
| 2. | Process conjunction |
| 3. | Analysis of existing compositions for pattern presence |
| 4. | Business rules, including music composition rules |
| 5. | Development of generation models for music compositions of the given type |
| 6. | Sound preparation |
| 7. | Data saving in the selected database |
| 8. | Atomic sound repository |
| 9. | Data reading from the selected database |
| 10. | Melody generator creation |
| 11. | Developed models stored in a database |
| 12. | Setting composition parameters and characteristics in the generator |
| 13. | User preference database |
| 14. | Music generator |
| 15. | Automatic generation of a digital score of the composition with the desired parameters |
| 16. | Rendering the sound from sound samples according to the digital score |
| 17. | Instrument parts |
| 18. | Record mixing and polishing |
| 19. | Verification of the composition and of its record by the critic module based on artificial intelligence (Al) |
| 20. | The final music record |
| 21. | Positive evaluation of the composition and of its record |
| 22. | Negative evaluation of the composition and of its record |
| 23. | Export to the distribution module of a dedicated platform |
| 24. | Music distribution |
| 25. | Database tile |
| 26. | Controller conforming to the MIDI standard |
| 27. | Creation area of the content on the technical level |
| 28. | Sequencer and sampler operation area |
| 28a. | Sequencer |
| 28.b. | Sampler |
| 29. | The area of final music contents on the artistic level |

1. A method of generating music contents according to the invention, wherein input sound samples are processed according to modification algorithms music input files, related, in particular, to characteristics such as tempo, mood of the composition, music genre, duration and the scope of content modulation is selected, with the effect being a composition with the intended artistic expression, wherein music contents are created on the technical level and on the artistic level, wherein on the level of contents creation on the technical level, the input music contents for the presence of patterns, the patterns are saved in a database of business rules and music composing rules used to develop generation models of music compositions of the given type, next a melody generator is created, in which a digital score of the part of the given instrument is created, wherein a database of atomic sounds is created simultaneously, and next the music contents are sent to the generator, in which parameters are set using a controller conforming to the MIDI standard and subjected to automatic generation of a digital score of the composition and parts for individual instruments are created and then rendered to music tracks for each of the instruments, followed by mixing of individual tracks into a record and the final version of the record is obtained, with the composition and its record then verified by an Al critic module.

2. The method of generating music contents according to claim 1, wherein the final music record is created using artificial intelligence algorithms at the stage of analysis for the presence of existing patterns, composition generation models are developed and the generator preparing sound is created.

3. The method of generating music contents according to claim 1, wherein sound samples are created and contents are saved in parallel in the repository.

4. The method of generating music contents according to claim 1, wherein the developed models are sent to be read and a digital score of the composition with the desired parameters is generated automatically.

5. The method of generating music contents according to claim 1, wherein sound tracks of instruments are rendered using resources from the repository.

6. The method of generating music contents according to claim 1, wherein the composition and its record are verified using artificial intelligence algorithms and the process of generating music contents is repeated from the beginning if the record does not pass verification.
